(19) United States
(12) Patent Application Publication
(10) Pub. No.: US 2011/0001716 A1
(43) Pub. Date: Jan. 6, 2011

(54) KEY MODULE AND PORTABLE ELECTRONIC DEVICE

(76) Inventors: Chao-Lung Chang, Taoyuan (TW); Liang-Ta Yeh, Taoyuan (TW)

Correspondence Address: NORTH AMERICA INTELLECTUAL PROPERTY CORPORATION, P.O. BOX 506, MERRIFIELD, VA, 22116, US

(21) Appl. No.: 12/828,290

(22) Filed: Jul. 1, 2010

(30) Foreign Application Priority Data
Jul. 1, 2009 (TW) 098211967

(51) Int. Cl. G06F 3/041

(52) U.S. Cl. 345/173

(57) ABSTRACT

The invention discloses a key module which includes a touch device, several navigation keys, and a control device. Therein the touch device includes a touchable surface for being touched by an object. When the object touches the touch device, the touch device generates a touch signal according the state of the touch of the object. The several navigation keys are set around the touch device. The control device is electrically connected to the touch device and the navigation keys respectively for receiving the touch signal from the touch device and determining the location the touch device is touched, the times of the object touching the touch device, or how long the touching device is touched.

### BACKGROUND OF THE INVENTION

1. Field of the Invention

The present invention is related to a key module and a portable electronic device that comprises the key module, and more particularly, to a key module and a portable electronic device that comprises the key module with touch functions.

2. Description of the Prior Art

In modern society, it is common for people to possess a portable (e.g. handheld) electronic product, such as a mobile phone, a personal digital assistant (PDA), or a digital camera, etc. To aid in communication between a user and the electronic product, a variety of input devices, such as miniature keyboards, buttons or touch screens, are utilized.

Taking smartphones which are commonly seen on the market as an example, the user can utilize a stylus or his/her fingertip to directly select/access functions displayed on a screen, without having to press the buttons repetitively. However, since the screen of the smartphone is relatively small, the size of the displayed function graphics (or text boxes) corresponding to different functions is also limited. Consequently, when the user selects a function graphic with his/her fingertip, his/her fingertip is likely to touch other function graphics as well, and the smartphone consequently executes unwanted operations. Corrective/calibration actions have to be performed regularly to ensure correct operation of the touch screen. Alternatively, when the user utilizes the stylus to select the displayed function graphics, the accuracy is higher than that of utilizing his/her fingertip, but the user has to hold the smartphone in one hand and the stylus in the other hand, causing inconvenience.

In contrast, for portable electronic products such as mobile phones that utilize physical buttons to operate, the buttons on the mobile phones are usually pressed repetitively to select or execute the desired functions as mentioned above. The accuracy of utilizing buttons for selection is likely to be higher than that of utilizing the touch screen, but is also more time consuming.

### SUMMARY OF THE INVENTION

The present invention provides a key module. The key module comprises a touch device, a plurality of navigation keys and a control device. The touch device comprises a touchable surface for being touched by at least one object, wherein when the object touches the touchable surface, the touch device generates a touch signal according to a touch of the object. The plurality of navigation keys is disposed around the touch device. The control device is electrically connected to the touch device and the plurality of navigation keys respectively. The control device receives the touch signal from the touch device and determines a position, a number of times or a duration for which the object touches the touchable surface.

The present invention further provides a portable electronic device. The portable electronic device comprises a case, a touch device, a plurality of navigation keys and a control device. The touch device is disposed on the case. The touch device comprises a touchable surface for being touched by at least one object, wherein when an object touches the touchable surface, the touch device generates a touch signal according to a touch of the object. The plurality of navigation keys is disposed around the touch device and exposed from the case. The control device is disposed within the case and electrically connected to the touch device and the plurality of navigation keys respectively. The control device receives the touch signal from the touch device and determines a position, a number of times or a duration for which the object touches the touchable surface.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a diagram illustrating the key module according to an embodiment of the present invention.

FIG. 1B is an illustration of the key module according to another embodiment of the present invention.

FIG. 1C is an illustration of the key module according to another embodiment of the present invention.

FIG. 2A is a diagram illustrating the portable electronic device according to an embodiment of the present invention.

FIG. 2B is a diagram illustrating the portable electronic device in FIG. 2A displaying a frame.

### DETAILED DESCRIPTION

The present invention provides a key module and a portable electronic device that utilizes the key module.

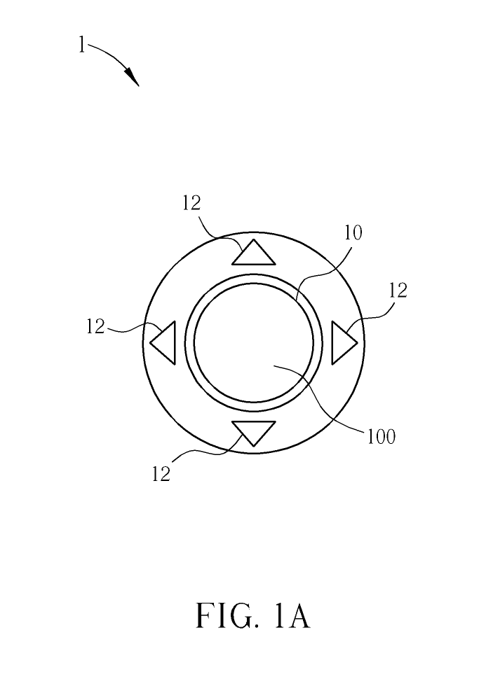

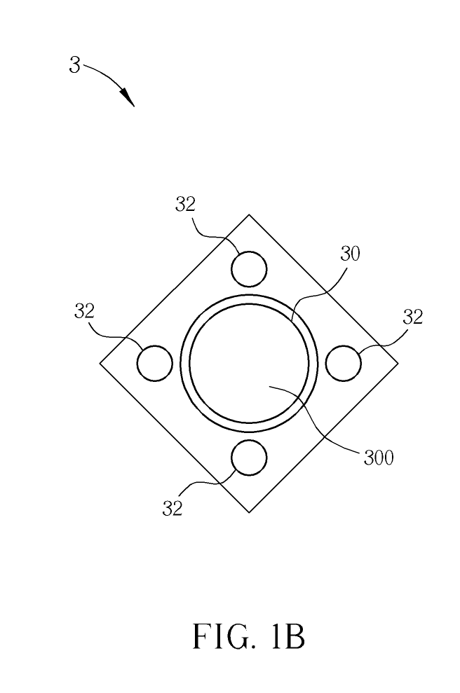

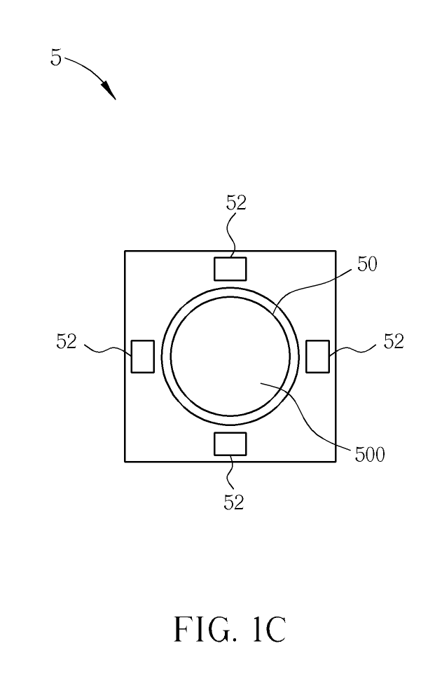

Please refer to FIG. 1A. FIG. 1A is a diagram illustrating a key module 1 according to an embodiment of the present invention. As illustrated in FIG. 1A, the key module 1 of the present invention comprises a touch device 10, a plurality of navigation keys 12 and a control device (not illustrated). The touch device 10 comprises a touchable surface 100 for being touched by an object (e.g. a fingertip). The plurality of navigation keys 12 is disposed around the touch device 10. For instance, the navigation keys 12 are disposed at the right side, the left side, the upper side, and the bottom side of the touch device 10. The control device is electrically connected to the touch device 10 and the plurality of navigation keys 12 respectively. In addition, the key module 1 further comprises a sectioning switch (not illustrated), disposed behind the touch device 10.

Practically, the touch device 10 comprises a plurality of capacitive sensing units (not illustrated), a plurality of resistive sensing units (not illustrated), or a combination of both, for detecting objects. When an object touches the touchable surface 100, the sensing units of the touch device 10 generate a touch signal corresponding to touch status between the object and the touchable surface 100. The control device, which is electrically connected to the touch device 10, receives the touch signal and determines the touch status, such as the location where the object touches the touchable surface 100 of the touch device 10, the number of times the touchable surface 100 is touched, or the duration of the touchable surface 100 being touched.

For instance, if the sensing units are capacitive, then the sensing units further comprise a plurality of electrodes. Since the human body is conductive, when the user touches the touchable surface 100 of the touch device 10, say, with the fingertip, a portion of electrical charges are shifted away, consequently changing current values of the sensing units in different areas. At the same time, the sensing units generate the touch signal that comprises data of the current values of the sensing units of different areas, and transmit the touch signal to the control device which is electrically connected to the touch device 10. The control device can then calculate the touch status, such as the location, the number of times, and the duration for which the finger tip (e.g. the conductive object) touches the touchable surface 100 of the touch device 10, according to the variation of current values of the sensing units of different areas.

Alternatively, if the sensing units are resistive, when the user touches the touchable surface 100 of the touch device 10, the voltage levels of the sensing units (e.g. where the touchable surface 100 is touched) are varied and the touch signal is generated accordingly. The touch signal is transmitted to the control device that is electrically connected to the touch device 10. The control device can then calculate the touch status such as the location, the number of times, and the duration for which the finger tip (e.g. the object) touches the touchable surface 100; subsequently the control device converts such information into digital data. It is noted that the sensing units are not limited to being capacitive and resistive. The sensing units can also be of other forms, such as infrared, optical, or wave-type, etc. Furthermore, when the object touches the touch device 10 to activate the sectioning switch, the sectioning switch generates difference switch signals according to the number of times the sectioning switch is turned on, and the switch signals are transmitted to the control device. In addition, when the plurality of navigation keys 12 are pressed by the object or the fingertip, corresponding signals are generated and transmitted to the control device.

According to different embodiments, the appearance (e.g. shape) of the key module 1 of the present invention is not limited to the illustration of FIG. 1A. For instance, the appearance of the key module 1 can also be other geometric shapes. Please refer to FIG. 1B and FIG. 1C. FIG. 1B is an illustration of the key module 3 according to another embodiment of the present invention. FIG. 1C is an illustration of the key module 5 according to another embodiment of the present invention. As shown in FIG. 1B, the key module 3 comprises a touch device 30, a plurality of navigation keys 32, a control device (not illustrated) and a sectioning switch (not illustrated). The touch device 30 further comprises a touchable surface 300 for being touched by an object. As shown in FIG. 1C, the key module 5 comprises a touch device 50, a plurality of navigation keys 52, a control device (not illustrated), and a sectioning switch (not illustrated). The touch device 50 further comprises a touchable surface 500 for being touched by an object. The functionalities and the operational details of the key modules illustrated in FIG. 1B and FIG. 1C are similar to those of FIG. 1A; the difference is the appearance and the relative operational description is omitted hereinafter.

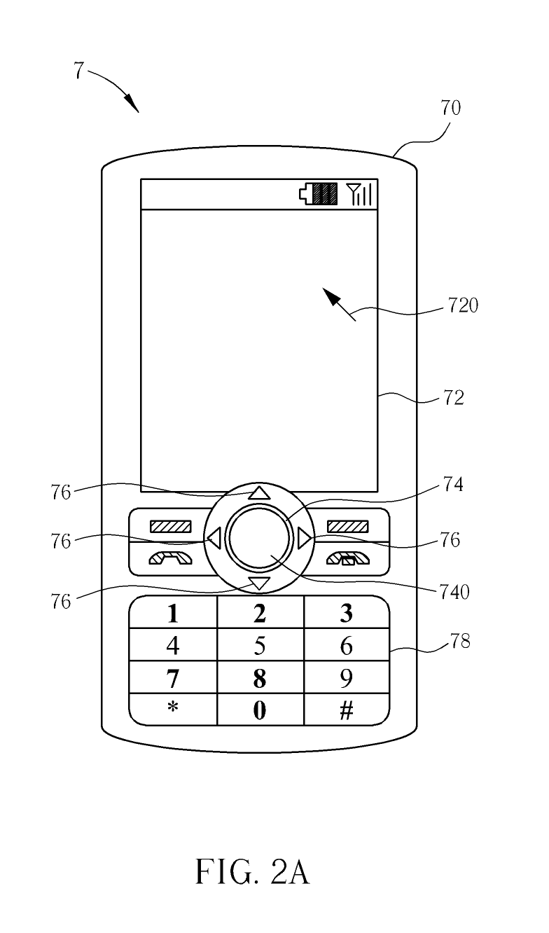

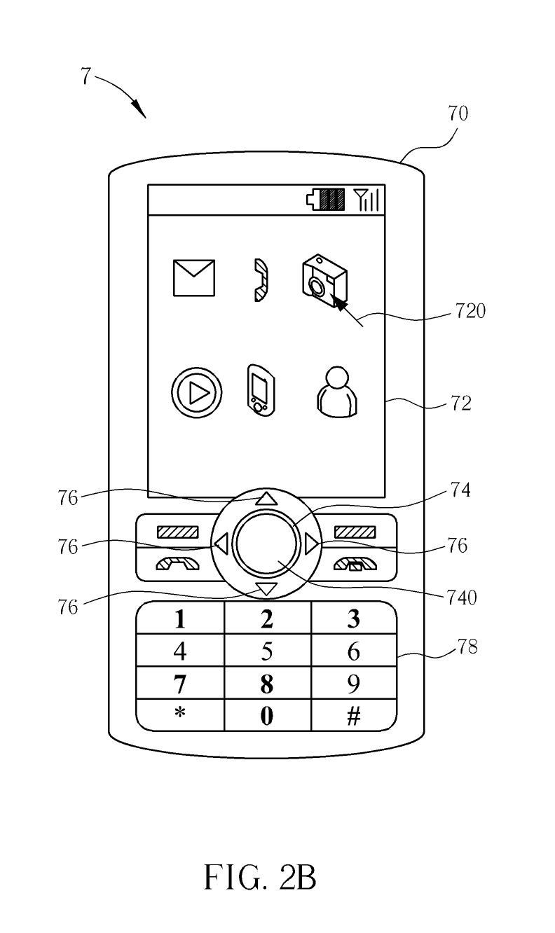

Another embodiment of the present invention provides a portable electronic device. Please refer to FIG. 2A and FIG. 2B. FIG. 2A is a diagram illustrating the portable electronic device 7 according to an embodiment of the present invention. FIG. 2B is a diagram illustrating the portable electronic device 7 in FIG. 2A displaying a frame. As shown in FIG. 2A, the portable electronic device 7 comprises a case 70, a monitor 72, a touch device 74, a plurality of navigation keys 76, a number key module 78, a control device (not illustrated) and a sectioning switch (not illustrated).

The monitor 72 is disposed on the case 70 for displaying frames and a cursor 720. With the aid of the displayed frame and the cursor 720, the user can then communicate with the portable electronic device 7 more conveniently. The touch device 74, which is disposed on the case 70, comprises a touchable surface 740 for being touched by an object, and sensing units (not illustrated) for detecting the object (e.g. when the object touches the touchable surface 740). The plurality of navigation keys 76 is disposed around the touch device 10, and exposed from the case 70. For instance, the navigation keys are disposed at the right side, the left side, the upper side, and the bottom side of the touch device 74. The aim of exposing the navigation keys from the case 70 is to make it easier for the user to press. The sectioning switch is disposed behind the touch device 74. The sectioning switch is usually turned on by the user touching the touch device 74.

The control device is disposed within the case 70. The control device is electrically connected to the touch device 74, the plurality of navigation keys 76 and the sectioning switch respectively. When an object (e.g. fingertip, stylus, etc.) touches the touchable surface 740, the sensing units of the touch device 74 generate a touch signal according to the touch status between the object and the touchable surface 740. The control device receives the touch signal from the touch device 74 for executing the predetermined function according to the touch status, such as the location, the number of times, or the duration for which the object touches the touchable surface 100 of the touch device 10. Furthermore, when the plurality of the navigation keys 12 are pressed by an object or the fingertip, corresponding signals are generated and transmitted to the control device. When the sectioning switch is turned on by an object touching the touchable surface 74, the sectioning switch generates different switch signals according to the number of times the sectioning switch has been turned on, and the generated switch signal is transmitted to the control device.

Practically, the portable electronic device 7 of the present invention can perform a number of functions, such as: capturing photos, message transmission, communication, and internet access, etc. For the user to select the desired function conveniently, the monitor 72 of the portable electronic device 7 displays function graphics (or text boxes) corresponding to different functions, as illustrated in FIG. 2B. For executing the functions displayed on the monitor 72, the user utilizes an object such as the fingertip or the stylus to contact (e.g. touch or slide, etc.) the touchable surface 740 of the touch device 74. When the object contacts the touchable surface 740, the current values or the voltage levels of the sensing units change, and subsequently, the touch signal is generated accordingly and transmitted to the control device. The control device calculates the position of the object touching the touchable surface 740 as well as the direction of the movement of the object. According to the position of the object touching the touchable surface 740 and the direction of the movement of the object, the control device controls the movement of the cursor 720 displayed on the monitor 72, so the movement direction and the movement distance of the cursor 720 are proportional to the movement direction and the movement distance of the object touching the touchable surface 740. Since the movement direction and the movement distance of the cursor 720 are proportional to those of the object touching the touchable surface 740, the user can then control the cursor 720 through the touchable surface 740 to move to the position of the function graphic corresponding to the desired function.

In addition to determining the position of the object touching the touchable surface 740, the control device can also determine the number of times the touchable surface 740 is touched by the object, and performs different predetermined functions according to the number of touches. Therefore, when user moves the cursor 720 to the position of the function graphic corresponding to the desired function, the user can then click the function graphic a number of times within a short period of time, for executing the function corresponding to the clicked function graphic. For instance, to perform the function corresponding to a function graphic, the predetermined condition can be: when the user controls the cursor 720 through the touchable surface 740 to click the function graphic corresponding to the particular function twice within a short period of time, the particular function is executed. As shown in FIG. 2B, the cursor 720 points to the camera function graphic, and if the user utilizes an object to touch the touchable surface 740 twice at the same position without moving the cursor 720, the camera function (e.g. photo capturing) is activated. It is noted that the condition to activate a predetermined function is not limited to the embodiments described above. For instance, the user may touch the touchable surface 740 three times to activate the desired function. The condition to activate a certain function can be set by the user or the manufacturer of the portable electronic device 7. Also, if the user touches the touchable surface 740 twice (or a predetermined number or times) at a position where the cursor 720 does not point to any function graphic, certain functions such as the main menu can be activated.

In addition to determining the position and the number of times the object touches the touchable surface 740, the control device can also determine the duration for which the touchable surface 740 is being touched. Therefore, the control device can also be configured to control the portable electronic device 7 to execute a predetermined function when the duration of the object touching the same position on the touchable surface 740 exceeds a predetermined value (e.g. 5 seconds). For instance, as shown in FIG. 2B, the cursor 720 points to the camera function graphic; if the user utilizes an object to continuously touch the touchable surface 740 at the same position without moving the cursor 720 for the cursor 720 to continuously select the function graphic that corresponds to the camera function, the camera function (e.g. photo capturing or recording, etc.) is activated. It is noted that the method to execute a predetermined function and the predetermined function to be executed are not limited to the descriptions above.

Other than communicating with the portable electronic device 7 through the touch device 74, the user can also communicate through the plurality of navigation keys 76. As shown in FIG. 2A and FIG. 2B, the user can press the navigation keys 76 as different navigation keys 76 control the cursor 720 to move in different directions. For instance, the navigation key 76 disposed on the upper side of the touch device 74 controls the cursor 720 to move towards the upper side of the monitor 72, and the navigation key 76 disposed on the left side of the touch device 74 controls the cursor 720 to move towards the left side of the monitor 72, and so on. The difference between the navigation keys 76 and the touch device 74 is that when utilizing the navigation key 76 to select the function graphic, the cursor 720 is moved for a predetermined distance, such as the distance between two different function graphics. Taking FIG. 2B as an example, the cursor 720 originally points to the camera function graphic, and when the navigation key 76 disposed at the left side of the touch device 74 is pressed, the cursor 720 moves towards the left to the communication function graphic directly.

In other embodiments, when utilizing the navigation keys 76 to select a certain function, the cursor 720 can be neglected, and the function graphic selected is highlighted instead to show the user this particular function graphic is selected. Also, the navigation keys 76 are not only limited to controlling the movement of the cursor 720; the navigation keys 76 can be configured to be a switch for turning on/off a certain function. For instance, when the display is in standby, the user can configure the navigation keys 76 so that when the navigation key 76 at the upper side of the touch device 74 is pressed (e.g. triggered), functions such as Bluetooth or music player are turned on, and when the navigation key 76 at the bottom side of the touch device 74 is pressed, the corresponding functions (e.g. Bluetooth or music player) are turned off, or in other cases, the speaker volume can be adjusted. Such configurations can be set according to the needs of the user and are not limited to the descriptions above.

Furthermore, the user can utilize the sectioning switch disposed behind the touch device 74 to activate predetermined functions of the portable electronic device 7. When the user activates the sectioning switch, the sectioning switch generates different switch signals according to the number of times the sectioning switch has been turned on, and the switch signals are transmitted to the control device. The control device then executes different predetermined functions according to the received switch signals. For instance, when the cursor 720 points to a function graphic, it can be configured so that by consecutively turning on the sectioning switch twice, the function that corresponds to the function graphic is executed; by consecutively turning on the sectioning switch three times, the function that corresponds to the function graphic is terminated. Such configurations can be set according to the need of the user and are not limited to the descriptions above.

In conclusion, each of the key module and the portable electronic device of the present invention comprises the touch device and the plurality of navigation keys. The user can utilize the navigation keys and the touch device to execute different functions and the movement of the cursor. In contrast to the prior art, the key module of the present invention not only has the advantage of being able to select the desired function graphic (e.g. function block, text block, etc.) accurately, the navigation keys disposed at different positions around the touch device allow the direction of selecting the function graphic to be adjusted, so as to save operation time. Alternatively, the user can touch the touch device of the key module through the fingertip (or other objects such as the stylus) to perform operations. When the user operates the portable electronic device of the present invention through the fingertip, other supplementary tools (e.g. a stylus) are not needed as the operation can be conveniently done with a single hand. The key module and the portable electronic device of the present invention have the advantages of physical keys and touch control.

Those skilled in the art will readily observe that numerous modifications and alterations of the device and method may be made while retaining the teachings of the invention.

What is claimed is:

1. A key module, comprising:
a touch device, comprising a touchable surface for being touched by at least one object, wherein when the object touches the touchable surface, the touch device generates a touch signal according to a touch of the object;
a plurality of navigation keys, disposed around the touch device; and
a control device, electrically connected to the touch device and the plurality of navigation keys respectively, the control device receiving the touch signal from the touch device and determining a position, a number of times or a duration for which the object touches the touchable surface.

2. The key module of claim 1, wherein the touch device further comprises a sensing unit, for detecting the object.

3. The key module of claim 2, wherein the sensing unit is capacitive or resistive.

4. The key module of claim 1, wherein the plurality of navigation keys are disposed at right side, left side, upper side and bottom side of the touch device respectively.

5. The key module of claim 1, further comprising a sectioning switch, disposed behind the touch device, wherein when the object touches the touchable surface and turns on the sectioning switch, the sectioning switch generates a switch signal.

6. A portable electronic device, comprising:
a case;
a touch device, disposed on the case, the touch device comprising a touchable surface for being touched by at least one object, wherein when an object touches the touchable surface, the touch device generates a touch signal according to a touch of the object;
a plurality of navigation keys, disposed around the touch device and exposed from the case; and
a control device, disposed within the case and electrically connected to the touch device and the plurality of navigation keys respectively, the control device receiving the touch signal from the touch device and determining a position, a number of times or a duration for which the object touches the touchable surface.

7. The portable electronic device of claim 6, wherein the touch device further comprises a sensing unit, for detecting the object.

8. The portable electronic device of claim 7, wherein the sensing unit is capacitive or resistive.

9. The portable electronic device of claim 6, wherein the plurality of navigation keys are disposed at right side, left side, upper side and bottom side of the touch device respectively.

10. The portable electronic device of claim 6, wherein the control device executes a predetermined function according to the determined position, number of times or duration.

11. The portable electronic device of claim 6, further comprising a sectioning switch, disposed behind the touch device, wherein when the object touches the touchable surface and turns on the sectioning switch, the sectioning switch generates a switch signal.

12. The portable electronic device of claim 6, further comprising a monitor, disposed on the case for displaying a frame and a cursor.

13. The portable electronic device of claim 12, wherein the control device controls movement of the cursor and a predetermined function of the portable electronic device, according to the determined position, the determined number of times or the determined duration for which the object touches the touches the touchable surface.

14. The portable electronic device of claim 12, wherein the control device controls the cursor to move a predetermined distance in a predetermined corresponding direction according to triggering a navigation key of the plurality of navigation keys.

15. The portable electronic device of claim 14, wherein the predetermined corresponding direction is towards right side, left side, upper side or bottom side of the frame.

16. The portable electronic device of claim 6, wherein the control device executes a predetermined function according to triggering a navigation key of the plurality of the navigation keys.
